(19) United States
(12) Patent Application Publication
(10) Pub. No.: US 2007/0223117 A1
(43) Pub. Date: Sep. 27, 2007

(54) Optical disc drive with an explosion-proof structure

(75) Inventors: Chao-Liang Chen, Taipei City (TW); Yi-Wei Lu, Taipei City (TW)

Correspondence Address: BACON & THOMAS, PLLC, 625 SLATERS LANE, FOURTH FLOOR, ALEXANDRIA, VA, 22314, US

(73) Assignee: ASUSTEK COMPUTER INC., Taipei City (TW)

(21) Appl. No.: 11/653,999

(22) Filed: Jan. 17, 2007

(30) Foreign Application Priority Data
Mar. 21, 2006 (TW) 095109613

(51) Int. Cl. G02B 5/04

(52) U.S. Cl. 359/831; 359/599

(57) ABSTRACT

The present invention discloses an optical disc drive with an explosion proof structure comprising a frame, a first guiding member pivoted to the frame, a second guiding member pivoted to the first guiding member, and a rotating member pivoted to the frame corresponding to an access opening on a side of the frame. When the rotating member rotates to a first position, the access opening is covered by a stopping flange of the rotating member, and when the rotating member rotates to a second position and a compact disc is inserted into the access opening, the compact disc drives the first guiding member and then to drive the second guiding member rotate the rotating member from the second position to the first position. Therefore, a fragment of a cracked compact disc inside the optical disc drive is prevented from jetting out of the optical disc drive effectively.

### BACKGROUND OF THE INVENTION

1. Field of the Invention

The present invention relates to an optical disc drive and more particular, to an optical disc drive with an explosion proof structure.

2. Description of Related Art

An ordinary electronic product, such as a computer or a home video player, has an optical disc drive. However, no matter an optical disc drive merely accessing data or a burner burning data to a compact disc, both of them receive a compact disc, so as to access the data stored on the compact disc or burn data to the compact disc.

Besides, following the development of high technology, the accessing or burning speed of a modern optical disc drive is getting faster and faster. In consequence, the revolving speed of a compact disc received in an optical disc drive must be getting faster and faster as well.

However, poor quality or a crack of a compact disc due to bad production may induce some problem. If such a defective compact disc is inserted into an optical disc drive, the detective or cracked video disc may explode into pieces in the optical disc drive during a high speed rotation. At this time, the fragment of the cracked compact disc may rush out of the optical disc drive at a high speed to injure a human accidentally.

Therefore, it is an urgent issue to that how to provide a optical disc drive that eliminates the aforesaid problem.

### SUMMARY OF THE INVENTION

According to the present invention, an optical disc drive having an explosion proof structure is provided. The optical disc drive comprises a frame, a first guiding member, a second guiding member, and a rotating member.

The frame has an access opening at one side thereof. The first guiding member is pivoted to the frame. The second guiding member is pivoted to the first guiding member.

Besides, the rotating member is pivoted to the frame and located on the access opening. When the rotating member rotates to a first position, a stopping flange covers the access opening.

When the rotating member rotates to a second position and a compact disc is inserted into the access opening, the compact disc contacts with the first guiding member, the compact disc drives the first guiding member, the first guiding member drives the second guiding member, and the second guiding member rotates the rotating member from the second position to the first position.

Therefore, where the stopping flange of the rotating member covers the access opening, the outward jetting of a fragment of a cracked compact disc received inside the optical disc drive is effectively prevented to protect the safety of a human.

The second guiding member may have a bending flange downwardly extending. The bending flange may comprise a guiding slope, and the rotating member may comprise a front part, a middle part, and a rear part. The front part may bend to form the stopping flange, the middle part may be pivoted to the frame, and the rear part may have a gear pivoted thereto corresponding to the guiding slope. Therefore, through foregoing mentioned structure, the guiding slope of the second guiding member may press the gear to make the rotating member rotate and then to make the stopping flange of the rotating member cover the access opening.

Besides, the stopping flange of the rotating member may extend upwards and cover the access opening when the rotating member rotates to the first position. Further, the stopping flange of the rotating member may comprise a curved surface.

Additionally, the frame may have at least one pin upwardly extending, and the second guiding member may comprise at least one sliding slot and the at least one pin may be located on the sliding slot.

Further, the compact disc may be inserted into the access opening in a first direction. The second guiding member may be moved in a second direction opposite to the first direction to a third position to contact with the rotating member.

### BRIEF DESCRIPTION OF THE DRAWINGS

FIG. 1 is an exploded view of a preferred embodiment of the present invention.

FIG. 2 is a perspective view of a preferred embodiment of the present invention.

FIG. 3 is a top view showing a preferred embodiment of the present invention in operation.

FIG. 4 is a sectional view of FIG. 3.

FIG. 5 is another top view showing a preferred embodiment of the present invention in operation.

FIG. 6 is a sectional view of FIG. 5.

FIG. 7 is a schematic sectional view of a preferred embodiment of the present invention in operation.

### DETAILED DESCRIPTION OF THE PREFERRED EMBODIMENT

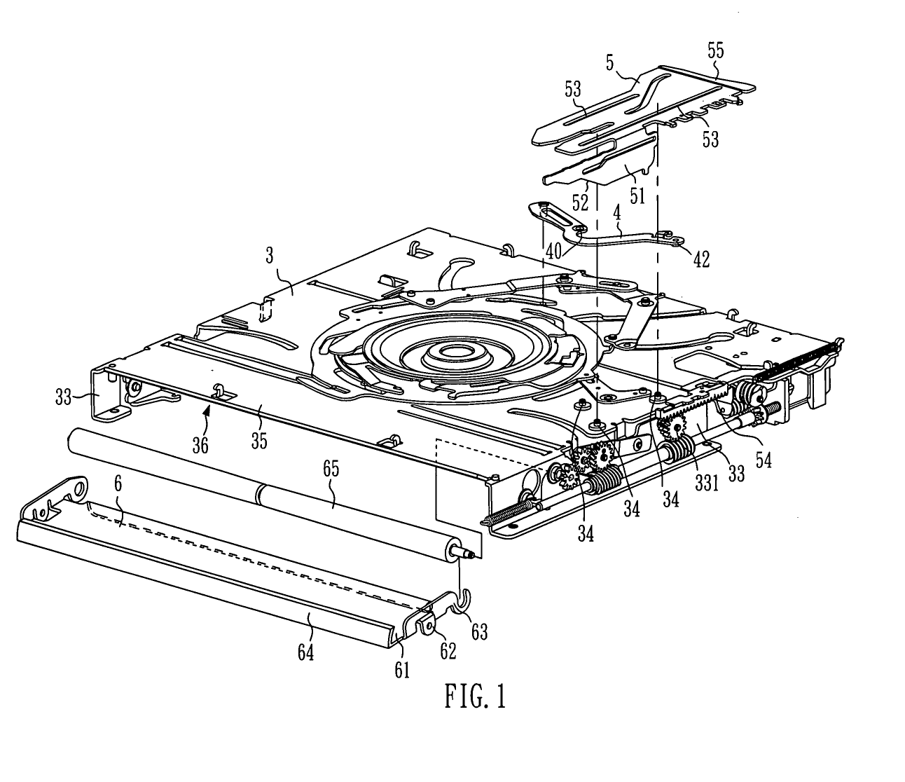

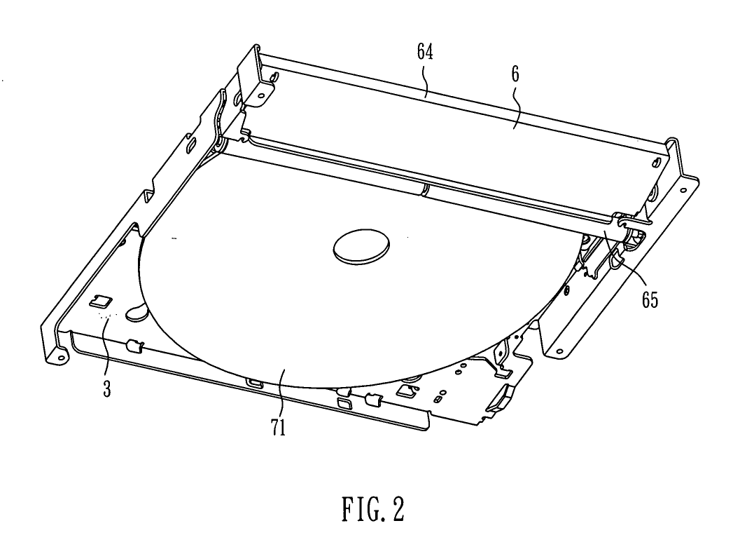

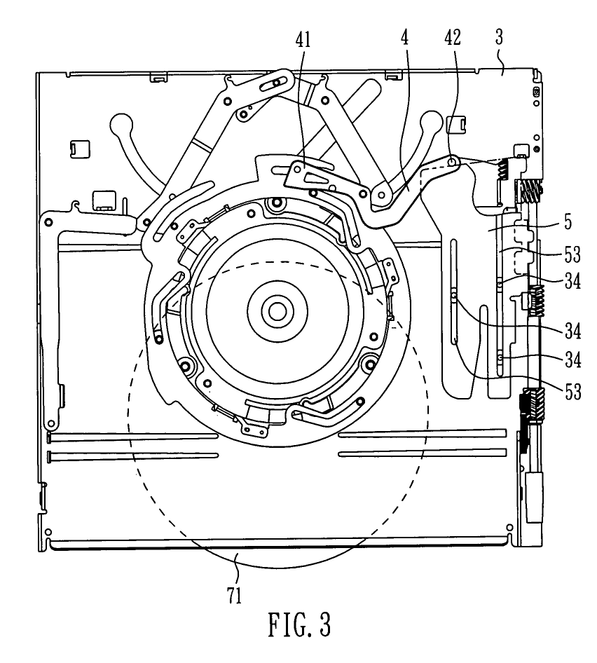

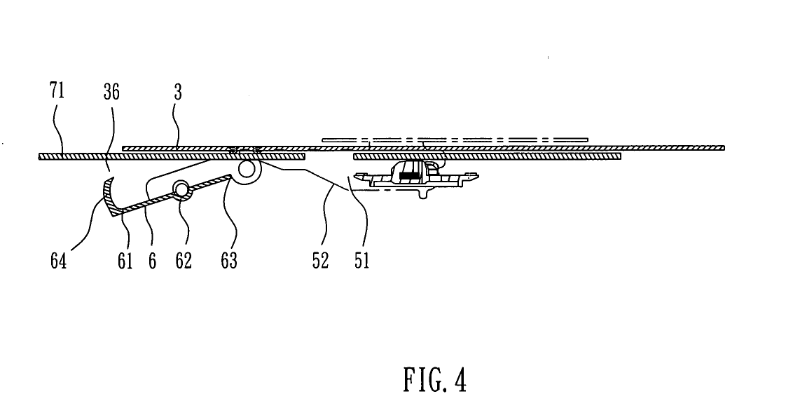

Referring to FIGS. 1-4, in which FIG. 1 shows an exploded view of a preferred embodiment of the present invention, FIG. 2. shows a perspective view of a preferred embodiment of the present invention, FIG. 3 shows a top view showing a preferred embodiment of the present invention in operation, and FIG. 4 shows a sectional view of FIG. 3. An essential internal structure of an optical disc drive having an explosion proof structure for accessing a compact disc 71 is shown.

The above-mentioned structure comprises a frame 3 and an access opening 36 located on one side of the frame 3.

In the present embodiment, the frame 3 comprises a top panel 35 and two side panels 33. The side panels 33 both extend downwardly from two opposite lateral sides of the top panel 35 respectively. The top panel 35 and the side panels 33 are surrounded by the above-mentioned access opening 36. Meanwhile, a gear 331 is assembled at one of the side panels 33.

Besides, a first guiding member 4 is pivoted to the frame 3. A second guiding member 5 is pivoted to the first guiding member 4. According to the present embodiment, the first guiding member 4 is a crank pivotally connected to a second end 55 of the second guiding member 5 with a first end 42. The first guiding member 4 also pivots to (a guiding member of) the frame 3 with a rotating center 40. In the present embodiment, the second guiding member 5 comprises a rack 54 engaged with the gear 331 during the moving of the second guiding member 5.

In the reference figures, the top panel 35 of the frame 3 has three pins 34 extending upwards. The second guiding member 5 also comprises two sliding slots 53. The pins 34 are located on the sliding slots 53 to guide the reciprocating movement of the second guiding member 5 relative to the frame 3.

Accordingly, a rotating member 6 is pivoted to the frame 3 and located on the side of the access opening 36. When the rotating member 6 rotates to a first position, a stopping flange 64 of the rotating member 6 may cover the access opening 36 and extend upwards till over the top panel 35. The flange 64 of the rotating member 6 comprises a curved surface.

In the present embodiment, the second guiding member 5 bends downwardly to form a bending flange 51. Under the bending flange 51, it comprises a guiding slope 52. The rotating member 6 comprises a front part 61, a middle part 62, and a rear part 63. The front part 61 bends upwards to form aforesaid flange 64. The middle part 62 is pivoted to the frame 3. The rear part 63 is provided with a roller 65 for pivoting and the roller 65 corresponds to the guiding slope 52 of the side flange 51.

Referring to FIGS. 1, 3 and 4 again, when inserting a compact disc 71 into the access opening 36, the rotating member 6 is moved to the second position (as shown in FIG. 3). At this time, the compact disc 71 contacts with and pushes the first guiding member 4, causing the first guiding member 4 to rotate around the rotating center 40 and to drive the second guiding member 5.

In the present embodiment, when inserting the compact disc 71 into the access opening 36, the compact disc 71 triggers a sensor switch (not shown), causing a motor (not shown) start rotating and further to drive the gear 33 of the frame 3 rotate. It is noted that when the compact disc 71 causes the second guiding member 5 start moving, in this instant the rack 54 of the second guiding member 5 is not engaged with the gear 331 of the frame 3 yet.

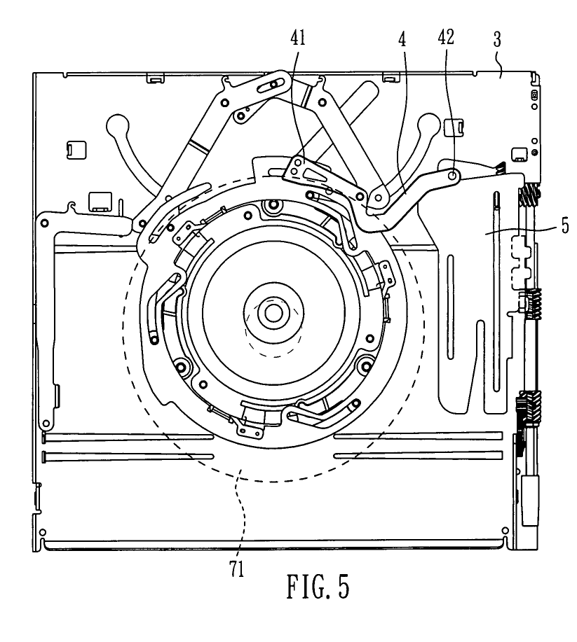

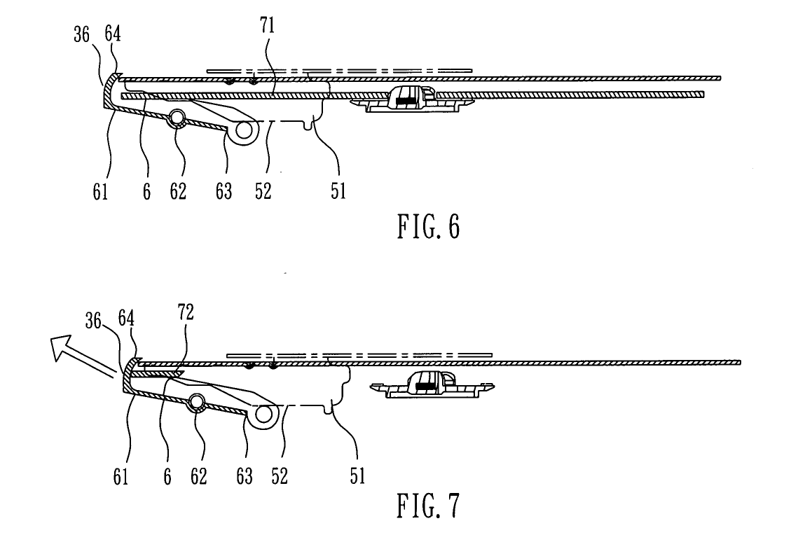

Referring to FIGS. 5˜7 and FIG. 1, FIG. 5 shows another top view showing a preferred embodiment of the present invention in operation, FIG. 6 shows a sectional view of FIG. 5, and FIG. 7 shows a schematic sectional view of a preferred embodiment of the present invention in operation. When continuously inserting the compact disc 71 into the access opening 36, the rack 54 of the second guiding member 5 is engaged with the gear 331 of the frame 3. Therefore, the rotating gear 331 allows the continuous moving of the second guiding member 5, thereby at this time the second guiding member 5 rotates the rotating member 6 from the second position to the first position (shown in FIG. 5).

When the rotating member 6 is moved from the second position to the first position, the guiding slope 52 of the second guiding member 5 stops against the roller 65 of the rotating member 6 to cause the upward rotation of the rotation member 6 around an axle, the middle part 62 and respective to the frame 3 to cover the access opening 36 and further extend upwards till over the top panel 35 (as shown in FIG. 6).

Meanwhile, because of the cover of the stopping flange 64, in case an explosion of the compact disc 71 occurs due to poor quality or any other defects to bring a fragment of the cracked compact disc 72 out (as shown in FIG. 7), through the designed stopping flange 64, the jetting out of the fragment of the cracked compact disc 72 is prevented. Therefore, the safety of a human is protected. Further, through the designed curved surface of the stopping flange 64, the jetting direction of the fragment of the cracked compact disc 72 is changed. The fragment of the cracked compact disc 72 is guided toward the root of the rotating member 6 rather than toward the end of the rotating member 6. This design enhances the security function of the present invention.

Besides, please referring to FIGS. 3, 5, and 6, the operation of the rotating member 6 rotating upwards with the middle part 62 as the axle and respective to the frame 3 is moved with the roller 65 of the rotating member 6 downwardly stopping against the guiding slope 52 of the second guiding member 5. As such design, the structure is simplified.

In the present embodiment, the foregoing mentioned compact disc 71 is inserted into the access opening 36 in a first direction, and the second guiding member 5 is moved in a second direction to a third position to contact with the rotating member 6. The first direction is opposite to the second direction.

Although the present invention has been explained in relation to preferred embodiment, it is to be understood that many other possible modifications and variations can be made without departing from the spirit and scope of the invention as hereinafter claimed.

What is claimed is:

1. An optical disc drive with an explosion proof structure for accessing a compact disc comprising:
a frame having an access opening at one side thereof;
a first guiding member pivoted to the frame;
a second guiding member pivoted to the first guiding member; and
a rotating member pivoted to the frame and located on the access opening, and when the rotating member rotates to a first position, a stopping flange of the rotating member covers the access opening;
wherein when the rotating member rotates to a second position and the compact disc is inserted into the access opening, the compact disc drives the first guiding member, the first guiding member drives the second guiding member, and the second guiding member rotates the rotating member from the second position to the first position cover.

2. The optical disc drive with an explosion proof structure as claimed in claim 1, wherein the video disc is inserted into the access opening in a first direction; the second guiding member is moved in a second direction opposite to the first direction to a third position to contact with the rotating member.

3. The optical disc drive with an explosion proof structure as claimed in claim 1, wherein the first guiding member is a crank, the first guiding member uses a rotating center to be pivoted on the frame, and when the compact disc drives the first guiding member, the first guiding member rotates around the rotating center.

4. The optical disc drive with an explosion proof structure as claimed in claim 1, wherein the first guiding member has a first end thereof pivoted to a second end of the second guiding member.

5. The optical disc drive with an explosion proof structure as claimed in claim 1, wherein the stopping flange of the rotating member extends upwards and covers the access opening when the rotating member rotates to the first position.

6. The optical disc drive with an explosion proof structure as claimed in claim 1, wherein the stopping flange of the rotating member has a curved surface.

7. The optical disc drive with an explosion proof structure as claimed in claim 1, wherein the frame comprises a top panel and two side panels respectively downwardly extending from two opposite lateral sides of the top panel, the top panel and the side panels surrounding the access opening.

8. The optical disc drive with an explosion proof structure as claimed in claim 1, wherein the second guiding member has a bending flange downwardly extending, the bending flange comprising a guiding slope; the rotating member comprises a front part, a middle part, and a rear part, the front part bends to form the stopping flange, the middle part is pivoted to the frame, and the rear part having a gear pivoted thereto corresponding to the guiding slope.

9. The optical disc drive with an explosion proof structure as claimed in claim 1, wherein the frame has at least one pin upwardly extending; the second guiding member comprises at least one sliding slot and the at least one pin is located on the sliding slot.
